(19) United States
(12) Patent Application Publication
(10) Pub. No.: US 2012/0092433 A1
(43) Pub. Date: Apr. 19, 2012

(54) Printing apparatus and printing control method

(76) Inventors: Tomoki Ogura, Chiba-shi (JP); Akio Naito, Chiba-shi (JP); Isao Amiya, Chiba-shi (JP)

(21) Appl. No.: 13/200,247

(22) Filed: Sep. 21, 2011

(30) Foreign Application Priority Data
Oct. 14, 2010 (JP) 2010-231652

(51) Int. Cl. B41J 2/325

(52) U.S. Cl. 347/215

(57) ABSTRACT

When a certain dot line is printed, in a case where a head power supply time for a thermal head unit is shorter than a motor stepping time so that an idle time is present, and it is predicted that, in a succeeding dot line, the head power supply time is longer than the motor stepping time and the motor stepping time becomes long, a printing control unit of a printing apparatus starts printing the succeeding dot line before succeeding motor stepping is started.

### BACKGROUND OF THE INVENTION

1. Field of the Invention

The present invention relates to a printing apparatus for performing printing by pressing a heated thermal head onto heat sensitive paper, and relates to a printing control method.

2. Description of the Related Art

In a thermal printer, printing speed is limited due to a period of time required for a heating element of a thermal head to generate heat, or divisional drive of the thermal head. Therefore, preheating has been performed on the heating element of the thermal head to shorten the period of time required to generate heat, thereby achieving an increase in printing speed (see, for example, Japanese Patent Application Laid-open No. Hei 4-71864).

However, only the above-mentioned method of performing preheating on the heating element of the thermal head may result in an insufficient printing speed in a case of performing printing within a low-speed range, or depending on the properties of the thermal head to be used.

### SUMMARY OF THE INVENTION

The present invention has been made in view of the above-mentioned circumstances, and it is therefore an object of the present invention to provide a printing apparatus and a printing control method which are capable of increasing printing speed when performing printing using a thermal head.

According to an aspect of the present invention, there is provided a printing apparatus, including: a thermal head unit including a plurality of heating elements arranged in line, the plurality of heating elements generating heat by supplying power thereto, and performing printing onto heat sensitive paper using the generated heat; a conveyance unit for conveying the heat sensitive paper in units of lines to be printed by the thermal head unit; and a printing control unit, which is configured to: determine, for each of the lines, a head power supply time, in which the power is supplied to the thermal head unit, and a conveyance time, which is an interval between conveyance of the heat sensitive paper by the conveyance unit and succeeding conveyance of the heat sensitive paper; and perform, when the head power supply time is shorter than the conveyance time in one of the lines, and the head power supply time is longer than the conveyance time in a line succeeding the one of the lines, control so as to start supplying the power to the thermal head unit for printing the line succeeding the one of the lines, before the conveyance unit starts conveying the heat sensitive paper for the line succeeding the one of the lines.

According to another aspect of the present invention, in the printing apparatus, the printing control unit is further configured to start, when the head power supply time is shorter than the conveyance time in the one of the lines, and the head power supply time is longer than the conveyance time in the line succeeding the one of the lines, supplying the power to the thermal head unit for printing the line succeeding the one of the lines, before the conveyance unit starts conveying the heat sensitive paper for the line succeeding the one of the lines, by a period of time within the conveyance time in the one of the lines, in which the power is not supplied to the thermal head unit.

Further, according to a further aspect of the present invention, there is provided a printing apparatus, including: a thermal head unit including a plurality of heating elements arranged in line, the plurality of heating elements generating heat by supplying power thereto, and performing printing onto heat sensitive paper using the generated heat; a conveyance unit for conveying the heat sensitive paper in units of lines to be printed by the thermal head unit; and a printing control unit, which is configured to: determine, for each of the lines, a head power supply time, in which the power is supplied to the thermal head unit, and a conveyance time, which is an interval between conveyance of the heat sensitive paper by the conveyance unit and succeeding conveyance of the heat sensitive paper; and control, when the head power supply time is longer than the conveyance time in one of the lines, and the head power supply time is shorter than the conveyance time in a line succeeding the one of the lines, the conveyance unit to start conveying the heat sensitive paper for the line succeeding the one of the lines, before starting supply of the power to the thermal head unit for printing the line succeeding the one of the lines.

According to a further aspect of the present invention, in the printing apparatus, the printing control unit is further configured to control, when the head power supply time is longer than the conveyance time in the one of the lines, and the head power supply time is shorter than the conveyance time in the line succeeding the one of the lines, the conveyance unit to start conveying the heat sensitive paper for the line succeeding the one of the lines, before starting the supply of the power to the thermal head unit for printing the line succeeding the one of the lines, so that the conveyance time of the line succeeding the one of the lines and the head power supply time of the line succeeding the one of the lines end at the same time.

According to a further aspect of the present invention, there is provided a printing control method for a printing apparatus, the printing apparatus including a thermal head unit including a plurality of heating elements arranged in line, the plurality of heating elements generating heat by supplying power thereto, and performing printing onto heat sensitive paper using the generated heat and a conveyance unit for conveying the heat sensitive paper in units of lines to be printed by the thermal head unit, the printing control method including: determining, for each of the lines, a head power supply time, in which the power is supplied to the thermal head unit, and a conveyance time, which is an interval between conveyance of the heat sensitive paper by the conveyance unit and succeeding conveyance of the heat sensitive paper; and starting, when the head power supply time is shorter than the conveyance time in one of the lines, and the head power supply time is longer than the conveyance time in a line succeeding the one of the lines, supplying the power to the thermal head unit for printing the line succeeding the one of the lines, before the conveyance unit starts conveying the heat sensitive paper for the line succeeding the one of the lines.

According to a further aspect of the present invention, there is provided a printing control method for a printing apparatus, the printing apparatus including a thermal head unit including a plurality of heating elements arranged in line, the plurality of heating elements generating heat by supplying power thereto, and performing printing onto heat sensitive paper using the generated heat and a conveyance unit for conveying the heat sensitive paper in units of lines to be printed by the thermal head unit, the printing control method including: determining, for each of the lines, a head power supply time, in which the power is supplied to the thermal head unit, and a conveyance time, which is an interval between conveyance of the heat sensitive paper by the conveyance unit and succeeding conveyance of the heat sensitive paper; and causing, when the head power supply time is longer than the conveyance time in one of the lines, and the head power supply time is shorter than the conveyance time in a line succeeding the one of the lines, the conveyance unit to start conveying the heat sensitive paper for the line succeeding the one of the lines, before starting supply of the power to the thermal head unit for printing the line succeeding the one of the lines.

According to the present invention, when printing is performed onto the heat sensitive paper for each line using the thermal printer, in a case where, in a certain line, an idle time in which power is not supplied to a thermal head is present within a motor stepping time, which is an interval provided until a stepping motor conveys the heat sensitive paper for a succeeding line, and it is predicted that, in the succeeding line, the idle time in which power is not supplied to the thermal head is not present and the motor stepping time becomes long, printing of the succeeding dot line is started before motor stepping for the succeeding line is started. Accordingly, the motor stepping time of the succeeding line is shortened. Further, in a case where it is predicted that, in a certain dot line, the idle time in which power is not supplied to the thermal head is not present and the motor stepping time is long, and in the succeeding line, the idle time in which power is not supplied to the thermal head is present within the motor stepping time, the motor stepping for the succeeding line is started during printing of the current line. Accordingly, the motor stepping time of the current line is shortened. In this manner, the motor stepping time is shortened, and hence a deceleration amount of the stepping motor is reduced. Thus, when the speed is increased again after the current dot line, the period of time required to increase the speed again is also shortened. As a result, throughput is improved and a printing wait time for a user is shortened.

Further, the degree of acceleration and deceleration of the stepping motor can be reduced to a smaller value than in the conventional case, and hence annoying printing noise due to the acceleration and deceleration can be reduced.

Further, in terms of the properties of the thermal printer, electric power efficiency is increased by performing high-speed printing. Thus, at the time of using a battery, it is possible to increase the number of printable sheets.

### BRIEF DESCRIPTION OF THE DRAWINGS

In the accompanying drawings:

FIG. 1 is a block diagram illustrating a configuration of a printing apparatus according to an embodiment of the present invention;

FIG. 2 is a block diagram illustrating a configuration of a thermal head unit according to the embodiment of the present invention;

FIG. 3 is a flow chart illustrating a printing control procedure to be executed by a printing control unit of the printing apparatus according to the embodiment of the present invention; and

FIGS. 4A, 4B, and 4C are time charts according to the embodiment of the present invention and an existing technology.

### DETAILED DESCRIPTION OF THE PREFERRED EMBODIMENT

Hereinbelow, an embodiment of the present invention is described in detail with reference to the accompanying drawings.

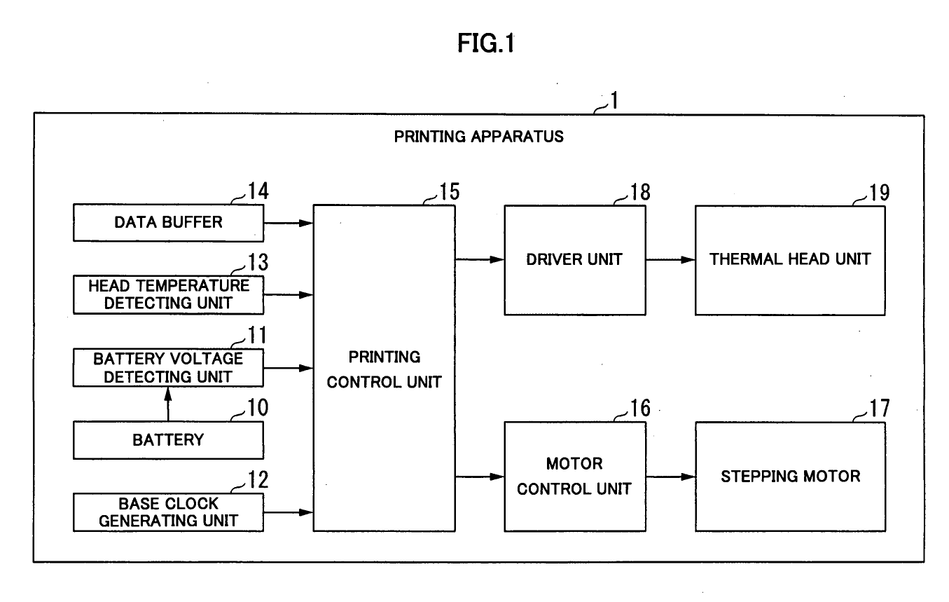

FIG. 1 is a block diagram illustrating a configuration of a printing apparatus 1 according to the embodiment of the present invention, which is illustrated by extracting only functional blocks relevant to the present invention.

The printing apparatus 1 of this embodiment is, for example, a thermal printer, and includes a battery 10, a battery voltage detecting unit 11, a base clock generating unit 12, a head temperature detecting unit 13, a data buffer 14, a printing control unit 15, a motor control unit 16, a stepping motor 17, a driver unit 18, and a thermal head unit 19.

The battery 10 supplies electric power through the battery voltage detecting unit 11 to the respective components, that is, the base clock generating unit 12, the head temperature detecting unit 13, the data buffer 14, the printing control unit 15, the motor control unit 16, the stepping motor 17, the driver unit 18, and the thermal head unit 19. The battery voltage detecting unit 11 measures the voltage of the battery 10, and outputs a measurement result to the printing control unit 15. The head temperature detecting unit 13 detects temperature of the thermal head unit 19. The data buffer 14 stores printing data.

The printing control unit 15 determines a tentative schedule for a motor stepping time (interval of paper feeding between a currently printed line and a succeeding line), and determines a head power supply time for the thermal head unit 19 (period of time in which power is supplied to the thermal head unit 19 so as to apply the heat of the thermal head unit 19 to heat sensitive paper) based on the voltage of the battery 10 detected by the battery voltage detecting unit 11, the temperature of the thermal head unit 19 detected by the head temperature detecting unit 13, the printing data stored in the data buffer 14, and the like. The printing control unit 15 determines schedules for timings of the motor stepping for performing paper feeding and the power supply to the head based on the tentative schedule for the motor stepping time and the head power supply time. The printing control unit 15 uses a clock generated by the base clock generating unit 12 to output, according to the determined schedules, a motor stepping control signal to the motor control unit 16 and a head power supply pulse to the driver unit 18.

The motor control unit 16 controls the stepping motor 17 according to the motor stepping control signal output from the printing control unit 15, to thereby perform paper feeding for conveying the heat sensitive paper from a printing position of the current line to a printing position of the succeeding line. The driver unit 18 controls the thermal head unit 19 according to the head power supply pulse output from the printing control unit 15, to thereby perform printing on the heat sensitive paper.

The following description is directed to a case where the thermal head unit 19 performs printing on a one-dot basis, and the motor control unit 16 controls the stepping motor 17 so as to feed the heat sensitive paper for every one dot line. Alternatively, the thermal head unit 19 may perform printing on a half-dot basis, and the motor control unit 16 may control the stepping motor 17 so as to feed the heat sensitive paper for every half-dot line.

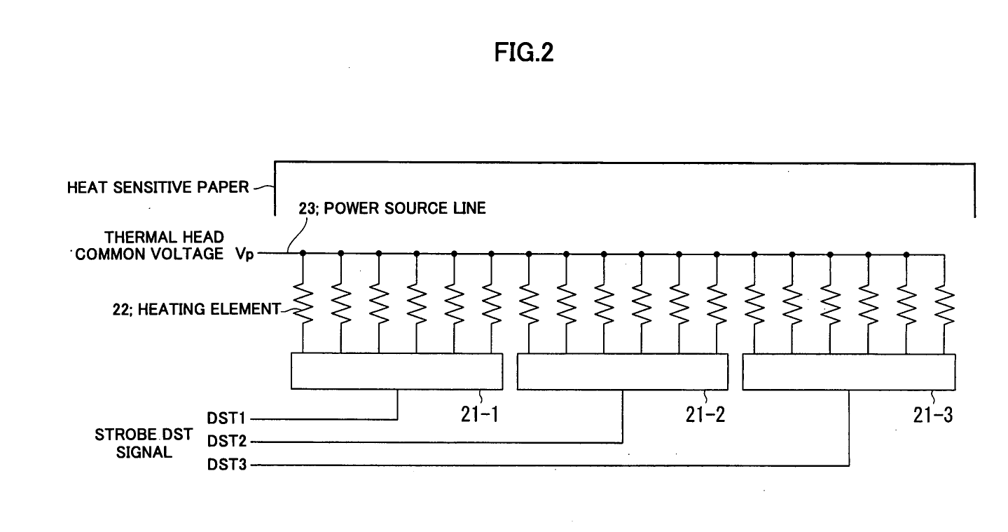

FIG. 2 is a block diagram illustrating a configuration of the thermal head unit 19. As illustrated in FIG. 2, the thermal head unit 19 includes m (m is an integer of 1 or more) blocks 21-1 to 21-m of thermal head. FIG. 2 illustrates a case where m=3. The blocks 21-1 to 21-m each include a predetermined number of heating elements 22 arranged in line. The driver unit 18 includes a drive block DSTi corresponding to each block 21-i (i=1 to m), to thereby output a strobe DST signal to the block 21-i. The block 21-i having received the strobe DST signal from the drive block DSTi (i=1 to m) applies a thermal head common voltage Vp, which is supplied from the battery 10 through a power source line 23, to the heating elements 22 corresponding to dots to be printed, which are indicated by the printing data. Through the application of the thermal head common voltage Vp, heat is generated in the heating elements 22, and printing is accordingly performed on the heat sensitive paper.

Note that, when printing is performed for one dot line, the printing control unit 15 determines whether to drive the blocks 21-1 to 21-m individually or drive a plurality of the blocks 21-1 to 21-m simultaneously, depending on the number of dots to be printed and the printing density in the dot line. For example, when all the blocks 21-1 to 21-m are driven simultaneously to perform printing for one dot line, the printing control unit 15 outputs the head power supply pulse once within the motor stepping time at the time of printing the dot line, and the strobe DST signals are output simultaneously from the drive blocks DST1 to DSTm of the driver unit 18. On the other hand, when the blocks 21-1 to 21-m are driven three times divisionally, the printing control unit 15 outputs the head power supply pulse three times divisionally within the motor stepping time at the time of printing the dot line, and the strobe DST signals are output three times divisionally from the drive blocks DST1 to DSTm of the driver unit 18.

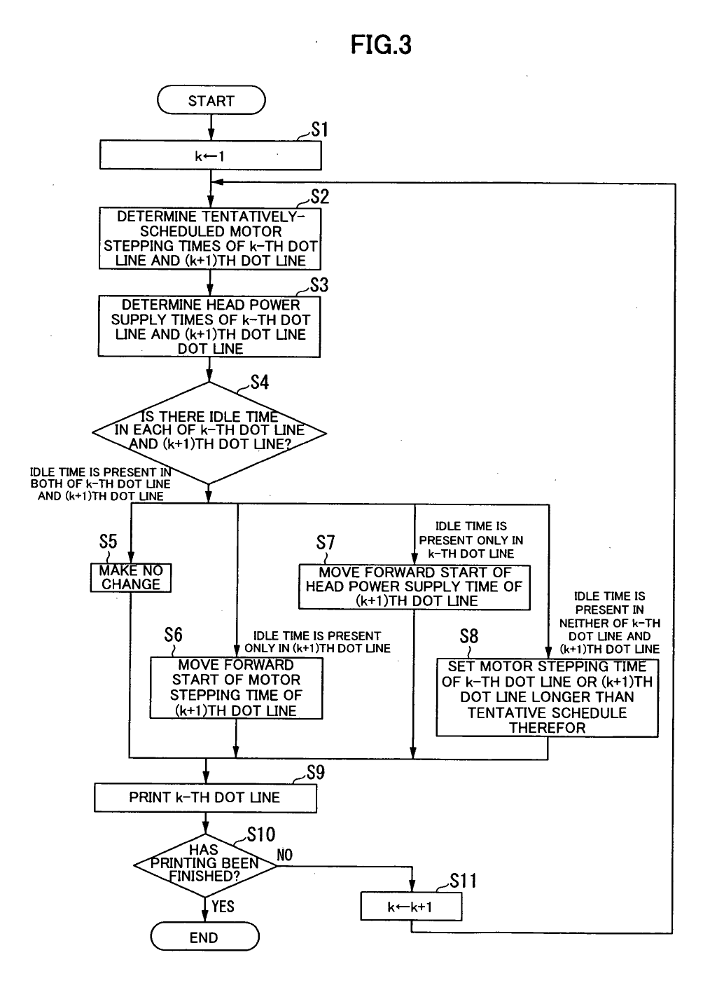

FIG. 3 is a flow chart illustrating a printing control procedure to be executed by the printing control unit 15 of the printing apparatus 1 according to this embodiment.

The stepping motor 17 needs to be accelerated gradually up to the maximum speed, and cannot be accelerated rapidly. Therefore, for example, in a certain dot line, the speed of the stepping motor 17 (hereinafter, referred to as “motor speed”) immediately before the dot line is low, and hence the stepping motor 17 cannot be advanced rapidly, with the result that an idle time in which power is not supplied to the thermal head unit 19 may be present. Further, for example, in a dot line having a small number of characters to be printed, the head power supply time may be short, and hence the idle time in which power is not supplied to the thermal head unit 19 may be present. This idle time may be present not only when the motor speed is low but also when the stepping motor 17 is being accelerated or when the stepping motor 17 is at the maximum speed. Therefore, in this embodiment, the printing speed is increased by reducing the idle time in which power is not supplied to the head, utilizing the fact that there is no particular influence on legibility even when the printing position is misaligned by about one dot line.

Specifically, when the idle time in which power is not supplied to the head is present in a certain dot line, if it is predicted that the idle time is not present in the succeeding dot line and the motor stepping time becomes long, the printing control unit 15 starts printing the succeeding dot line before the succeeding motor stepping is started. Further, when the idle time is not present in a certain dot line and the motor speed needs to be decreased because the head power supply time is long, if the idle time is present in the succeeding dot line, the printing control unit 15 starts the succeeding motor stepping during printing of the current dot line, and then prints the printing contents of the succeeding dot line.

Hereinbelow, referring to FIG. 3, the printing control procedure is described in detail. Note that, a dot line having a dot line number j (j is an integer of 1 or more) is referred to as “j-th dot line”.

In FIG. 3, the printing control unit 15 of the printing apparatus 1 sets a dot line number of an initial value to a dot line number k of a processing target (Step S1). In this case, the dot line number of the initial value is set as 1.

The printing control unit 15 determines tentative schedules for the motor stepping times (hereinafter, referred to as “tentatively-scheduled motor stepping times”) of the k-th dot line and the (k+1)th dot line (Step S2). For example, the printing control unit 15 determines the tentatively-scheduled motor stepping time of the k-th dot line from the motor speed in the (k−1)th dot line (when k=1, the (k−1)th dot line is assumed as a time point before starting printing; the same applies hereinafter). In addition, the printing control unit 15 determines the tentatively-scheduled motor stepping time of the (k+1)th dot line from the motor speed corresponding to the determined tentatively-scheduled motor stepping time of the k-th dot line.

Specifically, when the motor speed in the (k−1)th dot line reaches to the maximum speed, it is assumed that the maximum speed is maintained also in the k-th dot line, and the motor stepping time corresponding to the maximum speed is set as the tentatively-scheduled motor stepping time. Further, when the motor speed in the (k−1)th dot line does not reach to the maximum speed, it is assumed that a motor speed increased by a predetermined value from the motor speed in the (k−1)th dot line is the motor speed in the k-th dot line, and the motor stepping time corresponding to the assumed motor speed is set as the tentatively-scheduled motor stepping time. The tentatively-scheduled motor stepping time in the (k+1)th dot line is determined in the same manner based on the motor speed in the k-th dot line.

Note that, the tentatively-scheduled motor stepping time is a motor stepping time calculated by a motor stepping time determination method for a thermal printer according to the conventional technology, and an arbitrary motor stepping time determination method may be used therefor.

Subsequently, the printing control unit 15 determines head power supply times of the k-th dot line and the (k+1)th dot line (Step S3). When the divisional drive is performed in one dot line, the sum of all the divided head power supply times is set as the head power supply time of the dot line. The head power supply time of the k-th dot line is calculated based on, for example, the voltage of the battery 10 detected by the battery voltage detecting unit 11, the temperature of the thermal head unit 19 detected by the head temperature detecting unit 13, and the number of dots to be printed and the printing density in the k-th dot line, which are indicated by the printing data stored in the data buffer 14. The printing control unit 15 may calculate the head power supply time based further on, for example, sensitivity of the heat sensitive paper, printing speed, and other factors. The head power supply time in the (k+1)th dot line is determined in the same manner using the dots to be printed of the (k+1)th dot line in place of the dots to be printed of the k-th dot line.

Note that, the head power supply time is calculated by a head power supply time determination method for a thermal printer according to the conventional technology, and an arbitrary head power supply time determination method may be used therefor. However, when the power supply to the head is already started for the k-th dot line in the motor stepping for the (k−1)th dot line, the printing control unit 15 subtracts, from the determined head power supply time of the k-th dot line, a period of time from the start of the power supply to the head for the k-th dot line until the end of the motor stepping time of the (k−1)th dot line.

The printing control unit 15 determines which of (Branch a) to (Branch d) described below applies based on whether or not the idle time is present in each of the k-th dot line and the (k+1)th dot line (Step S4).

(Branch a) The idle time is present in both of the k-th dot line and the (k+1)th dot line. Specifically, the head power supply time in the k-th dot line falls within the tentatively-scheduled motor stepping time, and the head power supply time in the (k+1)th dot line also falls within the tentatively-scheduled motor stepping time.

(Branch b) The idle time is present only in the (k+1)th dot line. Specifically, the head power supply time in the k-th dot line does not fall within the tentatively-scheduled motor stepping time, and the head power supply time in the (k+1)th dot line falls within the tentatively-scheduled motor stepping time.

(Branch c) The idle time is present only in the k-th dot line. Specifically, the head power supply time in the k-th dot line falls within the tentatively-scheduled motor stepping time, and the head power supply time in the (k+1)th dot line does not fall within the tentatively-scheduled motor stepping time.

(Branch d) The idle time is present in neither of the k-th dot line and the (k+1)th dot line. Specifically, the head power supply time in the k-th dot line does not fall within the tentatively-scheduled motor stepping time, and the head power supply time in the (k+1)th dot line also does not fall within the tentatively-scheduled motor stepping time.

When the printing control unit 15 determines that (Branch a) applies (Step S4: the idle time is present in both of the k-th dot line and the (k+1)th dot line), there is no need to decrease the motor speed, and hence the printing control unit 15 determines that the printing is directly performed without changing the start timings of the motor stepping and the head power supply time for the (k+1)th dot line (Step S5). In other words, the printing control unit 15 determines the tentatively-scheduled motor stepping time of the k-th dot line directly as the motor stepping time of the k-th dot line. After the end of the motor stepping time of the (k−1)th dot line, the printing control unit 15 starts the motor stepping and the power supply to the head for the k-th dot line, and after the motor stepping time of the k-th dot line has elapsed since the start, the printing control unit 15 starts the motor stepping and the power supply to the head for the (k+1)th dot line.

When the printing control unit 15 determines that (Branch b) applies (Step S4: the idle time is present only in the (k+1)th dot line), the printing control unit 15 moves the start of the motor stepping time of the (k+1)th dot line forward from the end of the tentatively-scheduled motor stepping time of the k-th dot line (Step S6). Accordingly, the motor stepping time of the k-th dot line is shortened as compared to the tentatively-scheduled motor stepping time thereof. The head power supply time of the (k+1)th dot line is started after the end of the power supply to the head for the k-th dot line, and after the start of the motor stepping for the (k+1)th dot line.

As a result of moving forward the start of the motor stepping time of the (k+1)th dot line, when not all the head power supply times of the k-th dot line and the (k+1)th dot line fall within the sum of the motor stepping time of the k-th dot line and the tentatively-scheduled motor stepping time of the (k+1)th dot line, the printing control unit 15 extends the motor stepping time of the k-th dot line. In this manner, the printing control unit 15 sets all the head power supply times of the k-th dot line and the (k+1)th dot line to fall within the sum of the motor stepping time of the k-th dot line and the tentatively-scheduled motor stepping time of the (k+1)th dot line.

Instead of extending the motor stepping time of the k-th dot line, the printing control unit 15 may set the motor stepping time of the (k+1)th dot line longer than the tentatively-scheduled motor stepping time thereof. In this case, in Step S3 to be executed when the (k+1)th dot line is set as the dot line number of the processing target, the printing control unit 15 determines the head power supply time of the (k+1)th dot line, and adds the head power supply time that exceeds the sum of the motor stepping time of the k-th dot line and the tentatively-scheduled motor stepping time of the (k+1)th dot line. Alternatively, in Step S2 to be executed when the current (k+1)th dot line is set as the dot line number of the processing target, the printing control unit 15 adds the exceeding head power supply time described above to the tentatively-scheduled motor stepping time of the current (k+1)th dot line.

When the printing control unit 15 determines that (Branch c) applies (Step S4: the idle time is present only in the k-th dot line), the printing control unit 15 starts the power supply to the head for the (k+1)th dot line before the end of the tentatively-scheduled motor stepping time of the k-th dot line (Step S7). For example, immediately after the end of the power supply to the head for the k-th dot line, the printing control unit 15 starts the power supply to the head for the (k+1)th dot line. In this manner, the printing control unit 15 moves the start of the power supply to the head for the (k+1)th dot line forward by a period of time corresponding to the idle time that is present in the k-th dot line.

When the printing control unit 15 determines that (Branch d) applies (Step S4: the idle time is present in neither of the k-th dot line and the (k+1)th dot line), the printing control unit 15 sets the motor stepping time of the k-th dot line longer than the tentatively-scheduled motor stepping time thereof so that the sum of the tentatively-scheduled motor stepping time of the k-th dot line and the tentatively-scheduled motor stepping time of the (k+1)th dot line becomes equal to or longer than the sum of the head power supply time of the k-th dot line and the head power supply time of the (k+1)th dot line (Step S8).

Instead of extending the motor stepping time of the k-th dot line, the printing control unit 15 may set the motor stepping time of the (k+1)th dot line longer than the tentatively-scheduled motor stepping time thereof. In this case, in Step S3 to be executed when the current (k+1)th dot line is set as the dot line number of the processing target, the printing control unit 15 determines the head power supply time of the current (k+1)th dot line, and adds the time corresponding to an amount of the sum of the tentatively-scheduled motor stepping time of the k-th dot line and the tentatively-scheduled motor stepping time of the (k+1)th dot line that falls below the sum of the head power supply time of the k-th dot line and the head power supply time of the (k+1)th dot line. Alternatively, in Step S2 to be executed when the current (k+1)th dot line is set as the dot line number of the processing target, the printing control unit 15 adds the time that falls below the sum described above to the tentatively-scheduled motor stepping time of the current (k+1)th dot line.

When the printing control unit 15 sets the motor stepping time of the (k+1)th dot line longer than the tentatively-scheduled motor stepping time thereof, the decrease amount of the motor speed in the k-th dot line is reduced. In general, as the decrease amount becomes larger, a larger load is imposed on the motor, but by reducing the decrease amount, a smaller stepping motor 17 may be used. In addition, when the idle time is present in the (k+2)th dot line, (Branch b) applies at the time of succeeding scheduling, and the start of the motor stepping for the (k+2)th dot line can be moved forward. Thus, the motor stepping time of the (k+1)th dot line is shortened, and there arises a possibility that the motor speed can be increased again without the decrease to the low speed.

The printing control unit 15 outputs, according to the schedules for the timings of the motor stepping and the power supply to the head, which are determined in any one of Steps S5 to S8, a motor stepping control signal of the k-th dot line to the motor control unit 16 and a head power supply pulse of the k-th dot line to the driver unit 18. The motor control unit 16 controls the stepping motor 17 according to the motor stepping control signal, to thereby feed the heat sensitive paper. The driver unit 18 controls the thermal head unit 19 according to the head power supply pulse to perform printing of the k-th dot line onto the heat sensitive paper (Step S9).

When the printing control unit 15 determines that the printing based on the printing data is not finished (Step S10: NO), the printing control unit 15 adds 1 to the current dot line number k to increment the dot line number of the processing target by 1 (Step S11), and repeats the processing from Step S2. Then, when the printing control unit 15 determines that the printing based on the printing data is finished (Step S10: YES), the printing control unit 15 finishes the processing.

Note that, in the above-mentioned printing control procedure, the printing control unit 15 schedules the timings of the motor stepping time and the head power supply time for each one dot line while performing the printing, but the printing control unit 15 may first perform scheduling for all the dot lines to be printed and then perform the printing.

Next, referring to specific time charts, the printing control processing illustrated in FIG. 3 is described.

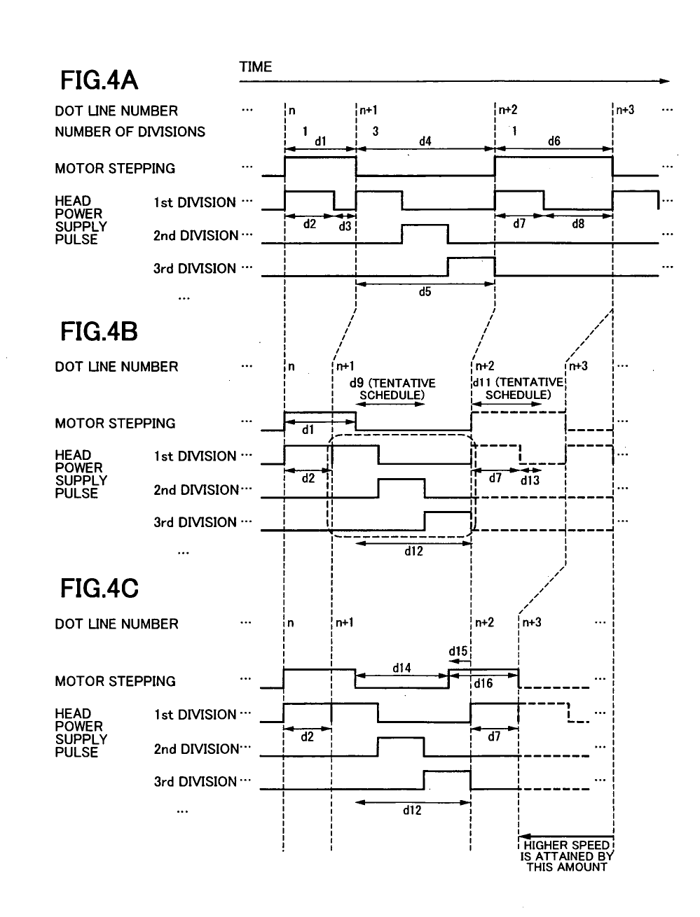

FIGS. 4A, 4B, and 4C are time charts of the motor stepping control signal and the head power supply pulse under the printing control according to this embodiment and the conventional technology in the case of using the same printing data.

Note that, when the motor stepping control signal output from the printing control unit 15 is switched from Low to High or High to Low, the motor control unit 16 drives the stepping motor 17 to convey the heat sensitive paper by an amount corresponding to one dot line. Further, when the head power supply pulse output from the printing control unit 15 is High, the driver unit 18 supplies power to the thermal head unit 19 to apply the thermal head common voltage Vp to the heating elements 22. Accordingly, heat is generated to perform printing onto the heat sensitive paper.

FIG. 4A is a time chart of the motor stepping control signal and the head power supply pulse for the n-th to (n+3)th dot lines under the printing control according to the conventional technology.

As illustrated in FIG. 4A, under the conventional printing control, the motor stepping control signal and the head power supply pulse are output so that, after the end of the motor stepping for the previous dot line, the motor stepping and the power supply to the head for the succeeding dot line are started. Specifically, after the end of the motor stepping for the n-th dot line, the motor stepping and the power supply to the head for the (n+1)th dot line are started. After the end of the motor stepping for the (n+1)th dot line, the motor stepping and the power supply to the head for the (n+2)th dot line are started. Further, in the same dot line, the motor stepping time is equal to or longer than the head power supply time.

In the n-th dot line, the motor speed reaches to the maximum speed, and a motor stepping time (d1) cannot be shortened any more. At this time, in the n-th dot line, the motor stepping time (d1) is longer than a head power supply time (d2), and hence an idle time (d3) in which power is not supplied to the head is present. In the (n+1)th dot line, the power supply to the head is performed three times divisionally, and hence a head power supply time (d5) becomes long. Thus, a motor stepping time (d4) is also long. Therefore, in the (n+2)th dot line, a head power supply time (d7) is short, but the motor speed needs to be increased from the motor speed in the (n+1)th dot line, and hence a motor stepping time (d6) can only be set slightly shorter than that in the (n+1)th dot line. As a result, in the (n+2)th dot line, an idle time (d8) is present.

FIG. 4B is a time chart based on the schedules generated by the printing control unit 15 of the printing apparatus 1 according to this embodiment when the n-th dot line is set as the processing target. Note that, in the n-th dot line, the scheduling for the (n+2)th and subsequent dot lines does not need to be performed, and in FIG. 4B, the case of scheduling using the conventional technology is represented by the dotted lines.

When the dot line number k of the processing target is n, the printing control unit 15 of the printing apparatus 1 determines the tentatively-scheduled motor stepping times of the n-th dot line and the (n+1)th dot line (Step S2 of FIG. 3). The tentatively-scheduled motor stepping time of the n-th dot line is the same as the motor stepping time (d1) of the n-th dot line illustrated in FIG. 4A. Further, a tentatively-scheduled motor stepping time (d9) of the (n+1)th dot line is the same as the tentatively-scheduled motor stepping time (d1) of the n-th dot line because the motor speed in the n-th dot line is the maximum speed.

Subsequently, the printing control unit 15 determines the head power supply times of the n-th dot line and the (n+1)th dot line (Step S3 of FIG. 3). The head power supply time of the n-th dot line and the head power supply time of the (n+1)th dot line which are determined at this time are respectively the same as the head power supply time (d2) of the n-th dot line and the head power supply time (d5) of the (n+1)th dot line which are illustrated in FIG. 4A.

The printing control unit 15 determines that (Branch c) applies (Step S4 of FIG. 3: the idle time is present only in the k-th dot line) because, in the n-th dot line, the tentatively-scheduled motor stepping time (d1) is longer than the head power supply time (d2) and in the (n+1)th dot line, the tentatively-scheduled motor stepping time (d9) is shorter than the head power supply time (d5). The printing control unit 15 moves the start of the power supply to the head for the (n+1)th dot line forward by a period of time corresponding to the idle time (d3) that is present in the n-th dot line (Step S7 of FIG. 3).

Specifically, the printing control unit 15 sets the tentatively-scheduled motor stepping time (d1) directly as the motor stepping time of the n-th dot line. Then, after the end of the motor stepping for the (n−1)th dot line, the printing control unit 15 starts the motor stepping and the power supply to the head for the n-th dot line, and after the motor stepping time (d1) has elapsed, the printing control unit 15 schedules to start the motor stepping for the (n+1)th dot line. In addition, the printing control unit 15 sets the start timing of the power supply to the head for the (n+1)th dot line as the end timing of the power supply to the head for the n-th dot line, to thereby move the start timing of the power supply to the head for the (n+1)th dot line forward by a period of time corresponding to the idle time (d3) from the start timing of the motor stepping for the (n+1)th dot line. In FIG. 4B, as is surrounded by the dotted line, the head power supply pulse is divided into three, and the start timings of all the divided head power supply pulses are moved forward.

FIG. 4C is a time chart based on the schedules generated by the printing control unit 15 of the printing apparatus 1 according to this embodiment when the (n+1)th dot line is set as the processing target. Note that, in the (n+1)th dot line, the scheduling for the (n+3)th and subsequent dot lines does not need to be performed, and in FIG. 4C, the case of scheduling using the conventional technology is represented by the dotted lines.

The printing control unit 15 of the printing apparatus 1 determines the tentatively-scheduled motor stepping times of the (n+1)th dot line and the (n+2)th dot line (Step S2 of FIG. 3). As illustrated in FIG. 4B, the tentatively-scheduled motor stepping time (d9) of the (n+1)th dot line is equal to or shorter than the motor stepping time (d1) of the n-th dot line. Further, a tentatively-scheduled motor stepping time (d11) of the (n+2)th dot line is equal to or shorter than the tentatively-scheduled motor stepping time (d9) of the (n+1)th dot line.

Subsequently, the printing control unit 15 determines the head power supply times of the (n+1)th dot line and the (n+2)th dot line (Step S3 of FIG. 3). As illustrated in FIG. 4B, the power supply time that is already started during the motor stepping for the n-th dot line is excluded from a head power supply time (d12) of the (n+1)th dot line. Further, the head power supply time (d7) of the (n+2)th dot line is the same as the head power supply time (d7) of the (n+2)th dot line illustrated in FIG. 4A.

The printing control unit 15 determines that (Branch b) applies (Step S4 of FIG. 3: the idle time is present only in the (k+1)th dot line) because the tentatively-scheduled motor stepping time (t9) of the (n+1)th dot line is shorter than the head power supply time (d12) and in the (n+2)th dot line, the tentatively-scheduled motor stepping time (d11) is longer than the head power supply time (d7). As illustrated in FIG. 4C, the printing control unit 15 moves the start of the motor stepping for the (n+2)th dot line forward by a period of time (d15) corresponding to an idle time (d13) that is present in the (n+2)th dot line (Step S6 of FIG. 3). At this time, the printing control unit 15 moves forward the start of the motor stepping for the (n+2)th dot line so that the end timing of the head power supply time (d7) of the (n+2)th dot line matches with the end timing of the motor stepping for the (n+2)th dot line. As a result, a motor stepping time (d16) of the (n+2)th dot line corresponds to the sum of the move-forward time (d15) and the head power supply time (d7) of the (n+2)th dot line. Note that, the motor speed in the (n+1)th dot line does not match with the motor speed in the (n+2)th dot line, and hence the printing control unit 15 determines the move-forward time (d15) corresponding to the idle time (d13) based on the difference in motor speed.

The sum of the head power supply time (d12) of the (n+1)th dot line and the head power supply time (d7) of the (n+2)th dot line does not fall within the sum of the tentatively-scheduled motor stepping time (d9) of the (n+1)th dot line and the motor stepping time (d16) of the (n+2)th dot line, and hence the printing control unit 15 extends the motor stepping time of the (n+1)th dot line. The printing control unit 15 determines a head power supply time (d14) of the (n+1)th dot line so that the head power supply times of the (n+1)th dot line and the (n+2)th dot line fall within the sum of the motor stepping times of the (n+1)th dot line and the (n+2)th dot line.

In the above-mentioned manner, the idle time is eliminated in the head power supply pulse for each of the (n+1)th dot line and the (n+2)th dot line, and hence a period of time for preheating of the thermal head is unnecessary in the (n+2)th dot line. Thus, the head power supply time of the (n+2)th dot line can be shortened, and further, the printing speed can be increased.

The printing control unit 15 of the printing apparatus 1 generates the schedules for the motor stepping time and the head power supply time as described above, and according to the time chart based on the schedules, outputs the motor stepping control signal and the head power supply pulse, to thereby perform printing onto the heat sensitive paper.

As described above, when a certain dot line is printed, in a case where the head power supply time is shorter than the motor stepping time so that the idle time is present, and it is predicted that, in the succeeding dot line, the head power supply time is longer than the motor stepping time and the motor stepping time becomes long, the printing apparatus of this embodiment starts printing the succeeding dot line before the start of the succeeding motor stepping.

Further, when a certain dot line is printed, in a case where the head power supply time is longer than the motor stepping time, and in the succeeding dot line, the head power supply time is shorter than the motor stepping time so that the idle time is present, the printing apparatus of this embodiment starts the succeeding motor stepping during printing of the current dot line, and then prints the printing contents of the succeeding dot line, thereby utilizing the idle time effectively.

Accordingly, the motor stepping time can be shortened, and the deceleration amount of the stepping motor is reduced. Thus, when the speed is increased again after the current dot line, the period of time required to increase the speed again is also shortened. As a result, throughput is improved and a printing wait time for a user is shortened.

Further, the degree of acceleration and deceleration of the motor can be reduced to a smaller value, and hence annoying printing noise due to the acceleration and deceleration can be reduced.

Further, the electric power efficiency of the thermal printer is increased by performing high-speed printing, and hence, at the time of using the battery, it is possible to increase the number of sheets printable within the capacity of the battery.

In this embodiment, the printing speed is increased by reducing the idle time in which power is not supplied to the head, utilizing the fact that there is no particular influence on legibility even when the printing position is misaligned by about one dot line. The period of time required for the stepping motor to perform paper feeding for one dot line within the motor stepping time, and the increase in dot size caused by performing the power supply to the thermal head with no idle time are also factors of causing no particular influence on legibility even when the printing position is misaligned by about one dot line.

Note that, the printing control unit 15 of the printing apparatus 1 is configured by a memory, a central processing unit (CPU), and the like. The functions of the printing control unit 15 are implemented by executing a program (not shown) for implementing the above-mentioned processing steps of the printing control unit 15, which is loaded onto the above-mentioned memory from a non-volatile memory or magnetic disk having the program recorded thereon.

What is claimed is:

1. A printing apparatus, comprising:
a thermal head unit including a plurality of heating elements arranged in line, the plurality of heating elements generating heat by supplying power thereto, and performing printing onto heat sensitive paper using the generated heat;
a conveyance unit for conveying the heat sensitive paper in units of lines to be printed by the thermal head unit; and
a printing control unit, which is configured to:
determine, for each of the lines, a head power supply time, in which the power is supplied to the thermal head unit, and a conveyance time, which is an interval between conveyance of the heat sensitive paper by the conveyance unit and succeeding conveyance of the heat sensitive paper; and
perform, when the head power supply time is shorter than the conveyance time in one of the lines, and the head power supply time is longer than the conveyance time in a line succeeding the one of the lines, control so as to start supplying the power to the thermal head unit for printing the line succeeding the one of the lines, before the conveyance unit starts conveying the heat sensitive paper for the line succeeding the one of the lines.

2. A printing apparatus according to claim 1, wherein the printing control unit is further configured to start, when the head power supply time is shorter than the conveyance time in the one of the lines, and the head power supply time is longer than the conveyance time in the line succeeding the one of the lines, supplying the power to the thermal head unit for printing the line succeeding the one of the lines, before the conveyance unit starts conveying the heat sensitive paper for the line succeeding the one of the lines, by a period of time within the conveyance time in the one of the lines, in which the power is not supplied to the thermal head unit.

3. A printing apparatus, comprising:
a thermal head unit including a plurality of heating elements arranged in line, the plurality of heating elements generating heat by supplying power thereto, and performing printing onto heat sensitive paper using the generated heat;
a conveyance unit for conveying the heat sensitive paper in units of lines to be printed by the thermal head unit; and
a printing control unit, which is configured to:
determine, for each of the lines, a head power supply time, in which the power is supplied to the thermal head unit, and a conveyance time, which is an interval between conveyance of the heat sensitive paper by the conveyance unit and succeeding conveyance of the heat sensitive paper; and
control, when the head power supply time is longer than the conveyance time in one of the lines, and the head power supply time is shorter than the conveyance time in a line succeeding the one of the lines, the conveyance unit to start conveying the heat sensitive paper for the line succeeding the one of the lines, before starting supply of the power to the thermal head unit for printing the line succeeding the one of the lines.

4. A printing apparatus according to claim 3, wherein the printing control unit is further configured to control, when the head power supply time is longer than the conveyance time in the one of the lines, and the head power supply time is shorter than the conveyance time in the line succeeding the one of the lines, the conveyance unit to start conveying the heat sensitive paper for the line succeeding the one of the lines, before starting the supply of the power to the thermal head unit for printing the line succeeding the one of the lines, so that the conveyance time of the line succeeding the one of the lines and the head power supply time of the line succeeding the one of the lines end at the same time.

5. A printing control method for a printing apparatus, the printing apparatus comprising a thermal head unit including a plurality of heating elements arranged in line, the plurality of heating elements generating heat by supplying power thereto, and performing printing onto heat sensitive paper using the generated heat and a conveyance unit for conveying the heat sensitive paper in units of lines to be printed by the thermal head unit, the printing control method comprising:
determining, for each of the lines, a head power supply time, in which the power is supplied to the thermal head unit, and a conveyance time, which is an interval between conveyance of the heat sensitive paper by the conveyance unit and succeeding conveyance of the heat sensitive paper; and
starting, when the head power supply time is shorter than the conveyance time in one of the lines, and the head power supply time is longer than the conveyance time in a line succeeding the one of the lines, supplying the power to the thermal head unit for printing the line succeeding the one of the lines, before the conveyance unit starts conveying the heat sensitive paper for the line succeeding the one of the lines.

6. A printing control method for a printing apparatus, the printing apparatus comprising a thermal head unit including a plurality of heating elements arranged in line, the plurality of heating elements generating heat by supplying power thereto, and performing printing onto heat sensitive paper using the generated heat and a conveyance unit for conveying the heat sensitive paper in units of lines to be printed by the thermal head unit, the printing control method comprising:
determining, for each of the lines, a head power supply time, in which the power is supplied to the thermal head unit, and a conveyance time, which is an interval between conveyance of the heat sensitive paper by the conveyance unit and succeeding conveyance of the heat sensitive paper; and
causing, when the head power supply time is longer than the conveyance time in one of the lines, and the head power supply time is shorter than the conveyance time in a line succeeding the one of the lines, the conveyance unit to start conveying the heat sensitive paper for the line succeeding the one of the lines, before starting supply of the power to the thermal head unit for printing the line succeeding the one of the lines.
